(19) United States
(12) Patent Application Publication
(10) Pub. No.: US 2026/0277406 A1
(43) Pub. Date: Sep. 17, 2026

(54) Advanced AI Dashboard

(71) Applicant: William Adams, Los Angeles, CA (US)

(72) Inventor: William Adams, Los Angeles, CA (US)

(21) Appl. No.: 19/563,964

(22) Filed: Mar. 11, 2026

Related U.S. Application Data
(60) Provisional application No. 63/770,776, filed on Mar. 12, 2025.

(51) Int. Cl. G06F 3/0484; G06F 3/0488; G06F 3/16

(52) U.S. Cl. CPC G06F 3/0484; G06F 3/0488; G06F 3/167

(57) ABSTRACT

Systems and methods for interfacing with one or more artificial intelligence (AI) personas within an active user session are disclosed. Conversational response data generated by an AI model is conditioned using the one or more AI personas through one or more persona-specific instructions. Media data, including synthesized speech and/or other multimedia content, is generated based at least partially on the conversational response data and is output by the system. While the media data is being output, the system detects subsequent user input events, suspends the output of the media data, and generates updated conversational response data and corresponding updated media data without terminating the session.

### CROSS-REFERENCE TO RELATED APPLICATIONS

This application claims the benefit of and priority to U.S. Provisional Patent Application Ser. No. 63/770,776, filed on Mar. 12, 2025, which is incorporated herein by reference in its entirety.

### BACKGROUND

Artificial intelligence (AI) systems are increasingly used to generate content and facilitate interactions between users and computing devices. Many modern artificial intelligence (AI) systems employ machine learning models, including large language models (LLMs), neural networks, and other generative models, to produce text, audio, images, and other forms of media. These models are typically trained on large datasets and are capable of generating contextually relevant responses based on received input. Large language models, in particular, are commonly used to generate conversational responses in chatbot and virtual assistant applications. However, conventional AI systems often fail to provide a unique user experience that is tailored to each user.

The subject matter claimed herein is not limited to embodiments that solve any disadvantages or that operate only in environments such as those described above. Rather, this background is only provided to illustrate one exemplary technology area where at least one embodiment described herein may be practiced.

### BRIEF SUMMARY

Disclosed embodiments include a system for interfacing with one or more AI personas, the system including a speaker; a microphone; a touch-sensitive display; and a processing unit connected to the speaker, the microphone, and the touch-sensitive display. The processing unit includes one or more processors and one or more non-transitory computer-readable storage devices that have one or more instructions stored thereon that are configured to cause the one or more processors to: receive, from the touch-sensitive display and/or the microphone, user input associated with an active user session. The active user session includes session state data that includes a persona identifier corresponding to a selected AI persona and one or more persona-specific instructions associated with the persona identifier. The instructions are further configured to cause the one or more processors to generate, using an AI model, conversational response data based on the user input and the session state data; generate media data based at least partially on the conversational response data and the persona identifier; output the media data using the speaker and/or the touch-sensitive display; detect, while outputting the media data, a subsequent user input event; and in response to detecting the subsequent user input event: suspend the output of the media data; update the session state data with the subsequent user input event to form updated session state data; generate, using the AI model and the one or more persona-specific instructions, updated conversational response data based on the updated session state data; generate updated media data based at least partially on the updated conversational response data; and output the updated media data using the speaker and/or the touch-sensitive display.

An additional or alternative embodiment includes a non-transitory computer-readable storage medium storing instructions that are executable by one or more processors to cause the one or more processors to perform operations comprising: receiving user input associated with an active user session, wherein the active user session comprises session state data; generating, using an AI model, conversational response data based on the user input and the session state data; generating media data based at least partially on the conversational response data; outputting the media data; detecting, while outputting the media data, a subsequent user input event; and in response to detecting the subsequent user input event: suspending output of the media data; updating the session state data with the subsequent user input event to form updated session state data; generating, using the AI model, updated conversational response data based on the updated session state data; generating updated media data based at least partially on the updated conversational response data; and outputting the updated media data.

An additional or alternative embodiment includes a system for dynamically managing AI personas within a conversational session, the system comprising: one or more processors and one or more non-transitory computer-readable storage devices that have one or more instructions stored thereon that are configured to cause the one or more processors to: receive a first user input associated with a conversational session, wherein the conversational session comprises session state data that comprises first persona-specific instructions that correspond to a first AI persona; generate, using an AI model and first persona-specific instructions, first conversational response data; receive, during the conversational session, a second user input indicating selection of a second AI persona; modify the session state data by replacing the first persona-specific instructions with second persona-specific instructions that correspond to the second AI persona while retaining at least a portion of session state data from the conversational session; and generate, using the AI model and the second persona-specific instructions, second conversational response data based at least partially on the portion of session state data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 shows a schematic model of a system for interfacing with one or more AI personas according to some embodiments described herein.

FIG. 2 shows a flowchart representation of a method associated with a system for interfacing with one or more AI personas according to at least one embodiment described herein.

FIG. 3 shows a conversation interface provided on a smartphone that is configured to implement a system for interfacing with one or more AI personas according to some embodiments described herein.

FIG. 4 shows a user interface dashboard provided on a smartphone that is configured to implement a system for interfacing with one or more AI personas according to some embodiments described herein.

FIG. 5 shows an example method of generating an AI persona according to some embodiments described herein.

FIG. 6 shows an example method of interfacing with one or more AI personas according to some embodiments described herein.

FIG. 7 illustrates an education interface provided on a smartphone that is configured to implement a system for interfacing with one or more AI personas according to some embodiments described herein.

### DETAILED DESCRIPTION

Disclosed embodiments include a system for interfacing with one or more artificial intelligence (AI) personas, the system including a speaker; a microphone; a touch-sensitive display; and a processing unit connected to the speaker, the microphone, and the touch-sensitive display. The processing unit includes one or more processors and one or more non-transitory computer-readable storage devices that have one or more instructions stored thereon that are configured to cause the one or more processors to: receive, from the touch-sensitive display and/or the microphone, user input associated with an active user session. The active user session includes session state data that includes a persona identifier corresponding to a selected AI persona and one or more persona-specific instructions associated with the persona identifier. The instructions are further configured to cause the one or more processors to generate, using an AI model, conversational response data based on the user input and the session state data; generate media data based at least partially on the conversational response data and the persona identifier; output the media data using the speaker and/or the touch-sensitive display; detect, while outputting the media data, a subsequent user input event; and in response to detecting the subsequent user input event: suspend the output of the media data; update the session state data with the subsequent user input event to form updated session state data; generate, using the AI model and the one or more persona-specific instructions, updated conversational response data based on the updated session state data; generate updated media data based at least partially on the updated conversational response data; and output the updated media data using the speaker and/or the touch-sensitive display.

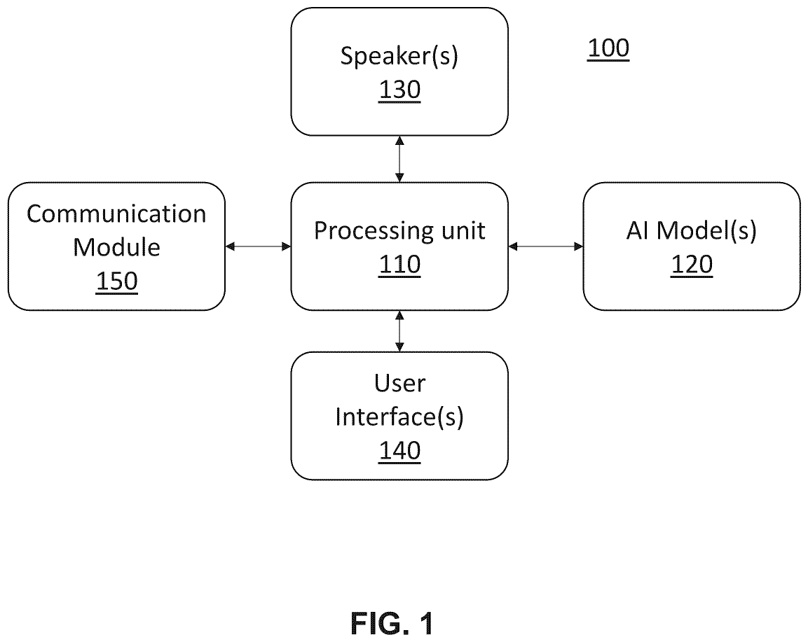

FIG. 1 shows a schematic model of a system for interfacing with one or more AI personas according to some embodiments described herein. As shown in FIG. 1, the system 100 may include a processing unit 110, one or more AI models 120, one or more speakers 130, one or more user interfaces 140, and a communication module 150.

In at least one embodiment, the processing unit 110 may include one or more processors and one or more non-transitory computer-readable storage devices storing instructions executable by the one or more processors. The processing unit 110 may be implemented as part of a mobile device, tablet, laptop computer, desktop computer, dedicated hardware device, or distributed computing system.

FIG. 1 also shows that the one or more AI models 120 may be executed locally by the processing unit 110, remotely on one or more servers, or in a hybrid configuration. The one or more AI models 120 may thus be accessible to and/or implemented by the processing unit 110. In embodiments that include the one or more AI models 120 remotely from the processing unit 110, a size and/or cost of the processing unit 110 may be reduced. In embodiments where the processing unit 110 is configured to implement the one or more AI models 120, the processing unit 110 may not require a connection to the internet, which may provide for offline functionality.

The communication module 150 may allow the processing unit 110 to communicate with one or more remote devices. By way of example and not limitation, the communication module 150 may allow the processing unit 110 to communicate with an NVIDIA® Jetson configured to implement the one or more AI models 120. This may allow a user to reduce the cost of the system 100. The communication module 150 may be physically separate from and connected to the processing unit 110 or may be implemented by the processing unit 110.

In at least one embodiment, the communication module 150 may implement any suitable wireless and/or wired communication protocol, for example Wi-Fi (including IEEE 802.11 standards), Ethernet, Bluetooth, Bluetooth Low Energy (BLE), cellular communication protocols (including 4G LTE, 5G, and successor standards), near-field communication (NFC), Zigbee, Z-Wave, Universal Serial Bus (USB), Thunderbolt, serial communication protocols, and/or proprietary communication protocols. In at least one embodiment, the communication module 150 may support Internet Protocol (IP)-based communications including Transmission Control Protocol (TCP), User Datagram Protocol (UDP), Hypertext Transfer Protocol (HTTP/HTTPS), WebSocket communication, Real-Time Transport Protocol (RTP), and/or other packet-based communication frameworks.

In at least one embodiment, the communication module 150 may facilitate communication between the processing unit 110 and one or more remote computing resources, including edge computing devices, dedicated AI accelerators, cloud computing servers, distributed computing clusters, and/or remote storage systems. For example, the communication module 150 may transmit model input data, session state data, persona-specific instructions, and/or media data to a remote device configured to execute the one or more AI models 120, and may receive generated conversational response data and/or media data in return.

The AI persona may be implemented by the one or more AI models 120 through the application of persona-specific instructions associated with a selected persona. The AI persona may thus generate conversational response data based on user input, as described in further detail herein. In at least one embodiment, the one or more AI models 120 may receive a prompt that includes (i) a master instruction set defining baseline system behavior, (ii) persona-specific instructions corresponding to the selected AI persona, and/or (iii) user input and conversation history. The one or more AI models 120 may generate a response conditioned on the prompt such that the response reflects characteristics of the selected AI persona while remaining within system-level constraints.

In at least one embodiment, the one or more AI models 120 may comprise a large language model (LLM), a transformer-based neural network, a generative pre-trained model, a multimodal model, or another machine learning model configured to generate text, audio, image, and/or structured data outputs based on received input. The one or more AI models 120 may be pre-trained on one or more large-scale datasets and optionally fine-tuned for conversational interaction, persona conditioning, domain-specific reasoning, and/or multimodal generation. In some embodiments, the one or more AI models 120 may include or be operatively connected to one or more auxiliary models, such as speech-to-text models, text-to-speech models, image generation models, embedding models, ranking models, or retrieval models, which collectively enable the generation of conversational response data and associated media data consistent with a selected AI persona.

In at least one embodiment, the one or more user interfaces 140 may include a touch-sensitive display configured to present graphical interface elements, text, and/or other visual elements and receive user input via touch. The one or more user interfaces 140 may additionally or alternatively include a microphone configured to receive voice input from a user. In at least one embodiment, the one or more speakers 130 may be configured to output audio generated by the system 100, for example synthesized speech corresponding to the AI persona.

In at least one embodiment, the instructions stored on the non-transitory computer-readable storage devices may cause the processing unit 110 to provide, via the one or more user interfaces 140, a user interface dashboard (user interface dashboard 346) configured to allow a user to select from one or more AI personas. Each AI persona may be associated with a persona identifier and one or more persona-specific instructions that influence output of the one or more AI models 120.

In at least one embodiment, an AI persona may be configured to represent a particular culture. For example, the persona-specific instructions for the AI persona may reflect geographic, linguistic, demographic, and/or sociocultural characteristics of a target population. Such characteristics may include, by way of example and not limitation, geographic region, national or local boundaries, dialect, slang usage, speech patterns, idiomatic expressions, formality levels, gender-associated communication styles, and other culturally influenced linguistic characteristics. The AI persona may therefore generate conversational response data that are not only contextually responsive but also culturally aligned with a particular culture.

Additionally or alternatively, the cultural characteristics of the AI persona may be implemented using the persona-specific instructions, system prompts, metadata tags, and/or other configuration data associated with the one or more AI models 120. For example, the persona-specific instructions may constrain vocabulary selection, tone, phrasing conventions, sentence structure, honorific usage, and/or culturally specific references to those associated with a particular culture. In at least such a manner, a single underlying model may be dynamically adapted to produce conversational response data reflective of distinct cultural identities without requiring retraining of the underlying model.

In at least one embodiment, the AI persona may be associated with a specially trained and/or fine-tuned AI model that incorporates culturally representative training data corresponding to a particular geographic region, community, or demographic group. Such training data may include region-specific literature, local dialect samples, culturally relevant knowledge bases, and/or communication style exemplars. The specially trained and/or fine-tuned AI model may produce conversational response data that more authentically reflect localized linguistic norms, slang, cadence, and/or discourse structure.

The persona-specific instructions and/or the specially trained or fine-tuned AI model associated with the AI persona may additionally or alternatively include and/or represent characteristics such as sex, race, gender identity, age group, and/or other demographic characteristics. Such characteristics may influence stylistic elements of communication, narrative framing, and/or vocabulary preferences, which may enable nuanced and/or context-sensitive outputs tailored to a particular community or audience segment.

The AI persona may also be configured to represent a plurality of different cultures. For example, the AI persona may be configured to represent an individual having exposure to multiple geographic regions, linguistic communities, or cultural backgrounds (e.g., an individual born in a first country and raised in a second country). In such embodiments, the persona-specific instructions and/or associated AI model may incorporate characteristics of each of the plurality of cultures, including blended dialectal features, vocabulary preferences, or communication styles. The system 100 may apply weighted or hierarchical cultural parameters to generate cross-culturally competent conversational response data.

The system 100 may be configured to implement a plurality of AI personas. Each AI persona may be configured to represent a different culture using the associated persona-specific instructions and/or associated specially-trained AI models. In at least such a way, the system 100 may provide for context-aware, culture-specific conversational response data.

In at least one embodiment, the system 100 may be configured to select, assign, or switch between the plurality of AI personas based on user profile data, detected geographic location, language settings, communication patterns, historical interaction data, and/or explicit user input. In some embodiments, the system 100 may dynamically modify the persona-specific instructions and/or send conversational inputs to a different AI persona during an active user session in response to detected contextual changes.

The instructions may further cause the processing unit 110 to provide a conversation interface configured to allow the user to interact with a selected AI persona via text input received through the touch-sensitive display and/or voice input received through the microphone. The conversation interface may present the conversational response data generated by the one or more AI models in text form on the touch-sensitive display and may additionally cause corresponding audio output to be generated and transmitted through the one or more speakers 130.

In at least one embodiment, the one or more speakers 130 may be a speaker that is integrated with a mobile device (for example, smartphone 300), the mobile device being configured to implement the system 100. In at least one embodiment, the one or more speakers 130 may be connected to the processing unit 110 over a wireless connection. By way of example and not limitation, the one or more speakers 130 may be an LG® xboom speaker, which may provide improved sound quality and features for the system 100 over conventional speakers.

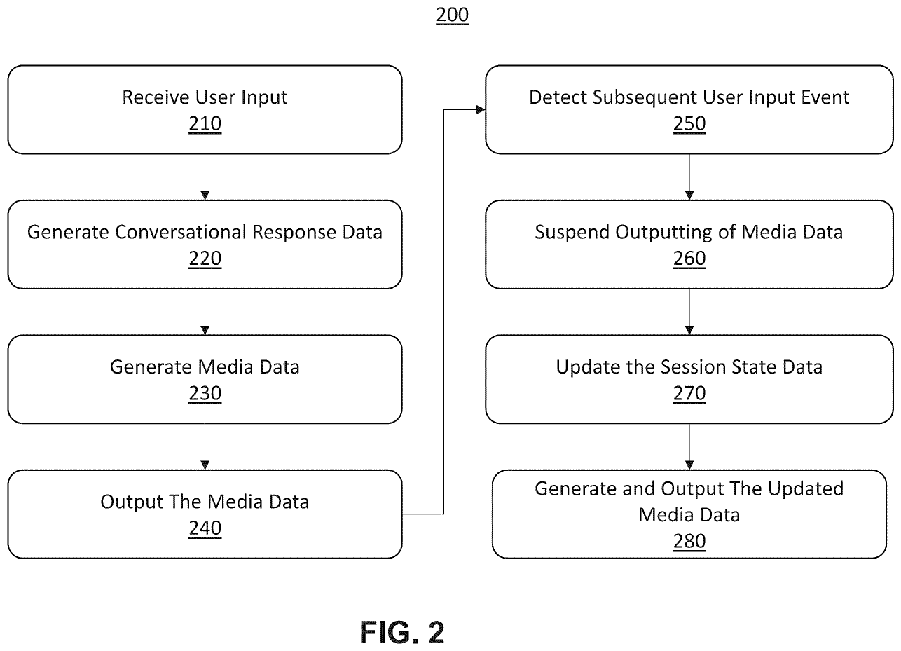

FIG. 2 shows a flowchart representation of a method associated with a system for interfacing with one or more AI personas according to at least one embodiment described herein. The method 200 may be implemented at least partially by the system 100, in particular at least partially by the processing unit 110. The method 200 may include a first step 210 of receiving user input.

In at least one embodiment, the first step 210 may include receiving one or more user inputs from a user interface (user interface(s) 140). The one or more user inputs may include a text input entered via a touch-sensitive display, a vocal input captured by a microphone, a selection of a suggested prompt displayed on the user interface, a tap or gesture input corresponding to a selectable interface element, or an upload of a media item. In at least one embodiment, vocal input received via the microphone may be converted into text by the processing unit 110 using a speech-to-text process. The received one or more user input may be associated with an active user session maintained by the processing unit 110.

According to at least one embodiment, the active user session may include session state data stored by and/or accessible to the processing unit 110. The session state data may include a persona identifier corresponding to a selected AI persona and one or more persona-specific instructions associated with the AI persona and/or persona identifier. The persona identifier may reference a stored persona profile that defines behavioral attributes that alter the response of an AI model (the one or more AI models 120) using one or more persona-specific instructions.

The session state data may also include a master prompt which defines baseline behavior of the one or more AI models 120. In at least one embodiment, the one or more persona-specific instructions may modify, supplement, and/or override portions of the master prompt to produce persona-specific behavior that is different relative to the baseline behavior. In at least one embodiment, the persona-specific instructions may define tone, style, vocabulary preferences (including word replacement and spelling preferences), response length tendencies, personality traits, subject-matter emphasis, and/or other behavioral characteristics for the one or more AI personas.

Additionally or alternatively, the session state data may include conversation history data including prior user inputs, prior AI-generated responses such as prior generated conversational response data, timestamps, system metadata, and/or modality indicators. The conversation history data may be appended to as the active user session progresses and may be used as contextual input when generating conversational response data (for example, during the second step 220). At least a portion of the session state data may persist across temporary interruptions and/or suspensions of media output.

The method 200 may also include a second step 220 of generating conversational response data. The second step 220 may include using the one or more AI models 120 to generate the conversational response data based on the user input and at least a portion of the session state data. As described herein, the session state data may include the persona identifier, the one or more persona-specific instructions, the master prompt, and/or at least a portion of the conversation history data.

In at least one embodiment, the processing unit 110 may be configured to construct a model input by combining the master prompt, the one or more persona-specific instructions associated with the AI persona, the conversation history data, and/or the most recently received user input. The model input may then be provided to the one or more AI models 120 to generate the conversational response data in textual form.

Additionally or alternatively, the second step 220 may include performing an information retrieval operation to obtain real-time and/or fact-based data. The retrieval operation may provide data which may be incorporated, optionally by the one or more AI models 120, into the conversational response data, and may include data such as real-time weather data, news information, financial data, sports scores, event listings, transportation information, product availability data, or other externally sourced information. In at least one embodiment, the processing unit 110 may transmit a query to one or more external data sources, application programming interfaces (APIs), databases, or search services to obtain the requested information.

In at least one embodiment, data obtained through the information retrieval operation may be incorporated into the session state data and/or combined with the received user input to form augmented model input. The one or more AI models 120 may then generate conversational response data based at least partially on the retrieved real-time and/or fact-based data. In this manner, the conversational response data may reflect both contextual conversation history and up-to-date external information, which may provide for an improved user experience and more reliable conversational response data that appears in a customized way according to the AI persona.

The method 200 may additionally include a third step 230 of generating media data. The third step 230 may include generating the media data based at least partially on the conversational response data and the persona identifier. In at least one embodiment, the media data is generated based only on the conversational response data and the persona-specific instructions associated with the persona identifier. This may allow for the generation of conversational response data in a single modality, which may reduce a complexity of the system 100.

Additionally or alternatively, the media data may correspond to one or more output modalities supported by the system 100. For example, the media data may include text data for display on the one or more user interfaces 140 and/or audio data generated from the conversational response data using a text-to-speech process. The text-to-speech process may utilize a voice identifier associated with and/or mapped to the AI persona and/or persona identifier stored in the session state data, such that different AI personas are associated with different synthesized voice and/or speech characteristics.

In at least one embodiment, the media data may include one or more media segments. The one or more media segments may include music segments, sound effects, images, graphical cards, animations, synthesized speech, and/or video segments. The one or more media segments may be appended to one another. For example, the media data may include a synthesized speech segment based on the AI persona followed by a music segment. The system 100 may thus be configured to provide a radio mode that includes both songs and synthesized speech, which may offer a personalized user experience to a user of the system 100. The one or more media segments may be output sequentially or at least some of the media segments may be output simultaneously with one another.

Additionally or alternatively, the media data may include one or more formatted text and/or graphic cards which may include multimedia content such as pictures, text, video, GIFs, and/or other multimedia content. The formatted cards may be generated based on structured data associated with the conversational response data and may include predefined layout templates that organize the multimedia content into visually distinct sections. The formatted cards may be rendered on the one or more user interfaces 140 and may be interactable, such that user interaction with a portion of the card causes the system 100 to retrieve additional information, initiate a related task, and/or generate a follow-up conversational response.

The method 200 may also include a fourth step 240 of outputting the media data. The fourth step 240 may include outputting audio data using the one or more speakers 130 and/or presenting text or visual data on the one or more user interfaces 140.

In at least one embodiment, the conversational response data may be displayed as text on the touch-sensitive display concurrently while outputting corresponding audio generated from the conversational response data. The audio output may be streamed incrementally as the text-to-speech generates audio segments, such that playback begins prior to completion of the entire response.

In the fourth step 240, the processing unit 110 may be configured to control sequencing, mixing, and/or timing of the outputting of the media data to produce a coordinated output experience. For example, the processing unit 110 may cause the media data corresponding to a synthesized speech output to be played at the same time as corresponding text data is displayed on the touch-sensitive screen.

The method 200 may additionally include a fifth step 250 of detecting a subsequent user input event. In at least one embodiment, the subsequent user input event may be detected while the media data generated in the third step 230 is being output in the fourth step 240.

The subsequent user input event may include activation of the microphone and receipt of audio data from the microphone, receipt of text input via the touch-sensitive display, selection of a different AI persona, activation of a user interface control, or another user interaction indicating a desire to modify or interrupt the ongoing interaction. In some embodiments, detection of the subsequent user input event may occur through continuous monitoring of input channels by the processing unit 110 while media output is in progress.

By way of example and not by limitation, the subsequent user input event may include (i) a selection of a different AI persona, (ii) a selection of a different voice identifier, (iii) activation of a pause, stop, skip, or replay control, (iv) submission of additional media content such as text, a file, a voice recording, etc., (v) a gesture input, (vi) a hardware button press, and/or (vii) another interaction indicating modification or interruption of the ongoing media output.

The method 200 may also include a sixth step 260 of suspending the outputting of the media data. In at least one embodiment, suspending the outputting of the media data may occur automatically in response to detecting the subsequent user input event in the fifth step 250. The suspension may be triggered without requiring completion of the outputting of the current media data, and the suspension may occur while outputting any of the media data described herein.

In at least one embodiment, suspending the outputting of the media data may include at least one of (i) pausing playback of audio data, (ii) stopping playback of audio data, (iii) fading out audio data over a predetermined interval, (iv) muting audio output, (v) halting display updates on the one or more user interfaces 140, (vi) discontinuing animation or visual rendering, and/or (vii) otherwise stopping output of the media data prior to completion. In at least one embodiment, suspension may occur substantially immediately upon detection of the subsequent user input event to reduce perceived latency.

In at least one embodiment in which the media data is streamed incrementally, the processing unit 110 may discontinue generation, buffering, transmission, and/or decoding of remaining media data that have not yet been output. The processing unit 110 may flush one or more output buffers associated with the one or more speakers 130 and/or user interface 140. The system 100 may also suspend any ongoing text-to-speech synthesis process or multimedia rendering pipeline associated with the prior conversational response data. This may provide for a reduced memory requirement.

In at least one embodiment, metadata associated with the interrupted media data may indicate a suspension point, playback position, or completion status. Such metadata may be stored in the session state data. The suspension point may be used for analytics, logging, later resumption of playback, or contextual awareness when generating updated conversational response data (for example in the seventh step 270).

The sixth step 260 may be performed entirely or at least partially by the processing unit 110 and/or at least partially by the one or more AI models 120. The sixth step 260 may provide for a reduced memory requirement, and may also provide for dynamic and seamless switching between AI personas within a single conversation.

The method 200 may additionally include a seventh step 270 of updating the session state data. In at least one embodiment, the seventh step 270 may include updating the session state data to incorporate the subsequent user input event detected in the fifth step 250.

In at least one additional or alternative embodiment, the subsequent user input event may include one or more of: (i) a text input entered via the touch-sensitive display, (ii) a vocal input captured by the microphone, (iii) a selection of a suggested prompt, (iv) a tap or gesture input corresponding to a selectable interface element, (v) an upload of a media item, (vi) activation of a hardware control, (vii) selection of a different AI persona, and/or (viii) any other user input that occurs subsequently to the user input in the first step 210. In at least one embodiment, vocal input received as part of the subsequent user input event may be converted into text using a speech-to-text process prior to generation of the updated conversational response data. The subsequent user input event may therefore correspond in form and structure to the initial user input received in the first step 210, but may occur during output of media data associated with a prior conversational response.

In at least one embodiment, the processing unit 110 may append the subsequent user input to the conversation history data stored in the session state data. The session state data may further be updated to reflect suspension of the prior media output, including any associated metadata indicating an interruption point or incomplete response.

In at least one embodiment, if the subsequent user input event includes selection of a different AI persona, the seventh step 270 may further include modifying the session state data by replacing first persona-specific instructions associated with a first persona identifier with second persona-specific instructions associated with a second persona identifier. At least a portion of the prior conversation history data may be retained such that the updated conversational response data is generated with contextual continuity across the persona change.

The method 200 may include an eighth step 280 of generating and outputting updated media data. The eighth step 280 may include using the one or more AI models 120 and the one or more persona-specific instructions to generate updated conversational response data based on the updated session state data. The updated media data may be generated based at least partially on the updated conversational response data. The updated media data may be output using the speaker and/or the touch-sensitive display.

In at least one embodiment, generating the updated media data may include initiating a new text-to-speech process associated with a current persona identifier, such that synthesized speech corresponding to the updated conversational response data is generated using a voice identifier mapped to the current AI persona. If the subsequent user input event includes selection of a different AI persona, the updated media data may reflect both a change in conversational content and a change in synthesized voice characteristics.

In at least one embodiment, the processing unit 110 may coordinate termination of any previously suspended media data and may output the updated media data to reduce latency between detection of the subsequent user input event and output of the updated media data. For example, one or more audio buffers associated with the prior conversational response data may be cleared, and new audio buffers may be allocated for streaming updated audio output to the one or more speakers 130. Text corresponding to the updated conversational response data may be rendered incrementally on the touch-sensitive display concurrently with streaming of corresponding audio segments.

Additionally or alternatively, the updated media data may include multimodal components such as formatted cards, images, infographics, music segments, animations, or other structured media elements generated in response to the subsequent user input event. The processing unit 110 may control sequencing, timing, and synchronization of the updated media data to provide a coordinated and continuous user experience despite the prior interruption. In at least such a manner, the method 200 may enable dynamic conversational continuity while maintaining responsiveness across diverse AI personas within the active user session.

Additionally or alternatively, the updated conversational response data may be generated using the one or more AI models 120 based on the updated session state data. The updated session state data may include the master prompt, the persona-specific instructions associated with the current persona identifier (which may be different from the persona identifier of the session state data before the subsequent user input event), the retained portion of the conversation history data, and the newly received subsequent user input.

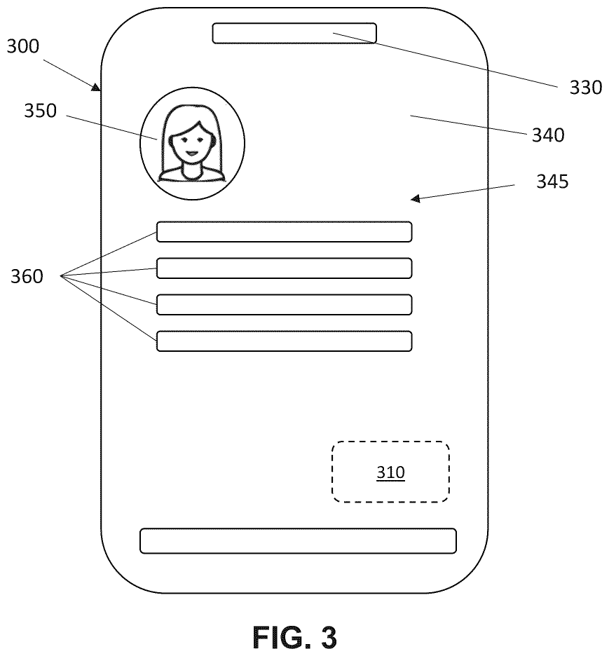

FIG. 3 shows a conversation interface provided on a smartphone that is configured to implement a system for interfacing with one or more AI personas according to some embodiments described herein. As shown in FIG. 3, the system 100 may be implemented using a mobile device such as a smartphone 300. The smartphone 300 may include a processing unit 310, a speaker 330, and a user interface 340 which may be similar to or the same as the processing unit 110, the one or more speakers 130, and the one or more user interfaces 140, respectively. The user interface 340 shown in FIG. 3 includes a touch-sensitive display and a microphone.

In at least one embodiment, the processing unit 310 may be configured to provide on the touch-sensitive display a conversation interface 345. The conversation interface 345 may allow users to provide the user input to the smartphone 300. The conversation interface 345 may display one or more AI personas 350 and allow for the selection of the one or more AI personas 350. As described herein, the one or more AI personas 350 may each have distinct characteristic responses, which may include distinct synthesized voices, speech patterns, and/or other characteristics. The responses of the one or more AI personas 350 may be generated by one or more AI models (AI model(s) 120) as described herein.

In at least one embodiment, the user may select an AI persona 350 and engage in a conversation with the selected AI persona 350. The user interface 340 may allow the user to enter text, voice, or other input to interact with the selected AI persona 350. In response to receiving user inputs, the AI persona 350 may respond with a response that was generated based on the persona-specific instructions.

FIG. 3 also shows that one or more preconfigured prompts 360 may be displayed to the user on the touch-sensitive display. The one or more preconfigured prompts 360 may be generated by the one or more AI models and/or may relate to a selected topic for the conversation.

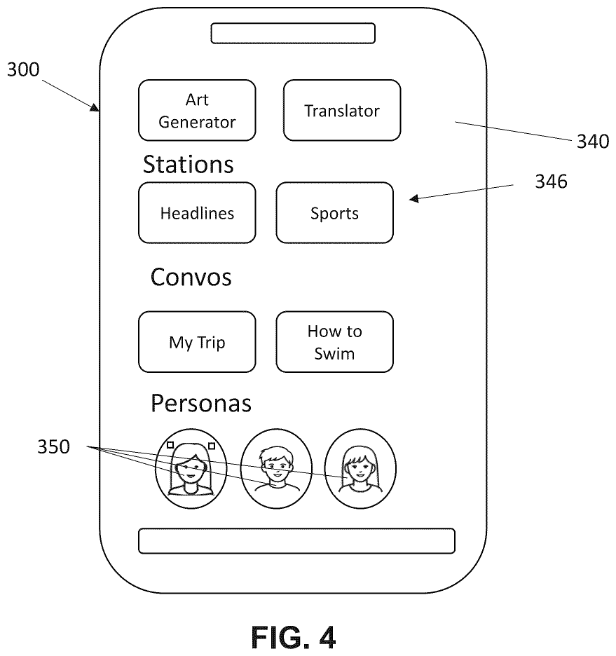

FIG. 4 shows a user interface dashboard provided on a smartphone that is configured to implement a system for interfacing with one or more AI personas according to some embodiments described herein. FIG. 4 shows that at least one embodiment of the present disclosure relates to a system (the system 100) for interfacing with one or more AI personas to provide a multi-modal experience. For example, as described herein, the system 100 may provide a user interface dashboard 346 on the user interface 340.

In at least one embodiment, the user interface dashboard 346 may allow a user to select one or more AI functions and/or conduct one or more AI operations that may relate to one of the one or more AI personas 350. The user interface dashboard 346 may present selectable interface elements corresponding to different operational modes, tools, and/or capabilities that are accessible within an active user session and/or conditioned on a selected AI persona 350. The one or more AI functions may be executed using the one or more AI models 120 and/or one or more auxiliary models that are operatively connected to the processing unit 110. Selection of a particular AI function may cause the processing unit 110 to modify session state data, load corresponding function-specific instructions, and generate model input that incorporates persona-specific instructions in combination with function-specific instructions.

For example, the user interface dashboard 346 may allow a user to generate art using the one or more AI models 120. In such embodiments, the AI persona 350 may influence stylistic attributes of generated artwork, including color palette, composition preferences, thematic tone, genre selection, abstraction level, or narrative elements associated with the persona. The system 100 may transmit a text-based prompt, optionally combined with persona-specific instructions, to an image generation model of the one or more AI models 120. The resulting generated image data may be rendered on the touch-sensitive display and may optionally be stored within session state data or within a project object (e.g., the project object described herein). In some embodiments, the AI persona may generate descriptive commentary, titles, or contextual explanations associated with the generated artwork in a manner consistent with the persona's defined tone and personality traits.

Additionally or alternatively, the user interface dashboard 346 may allow a user to translate text, audio, and/or visual data using the one or more AI models 120. In at least one embodiment, translation operations may include text-to-text translation, speech-to-text transcription followed by translation, text-to-speech translation with persona-specific voice characteristics, or optical character recognition (OCR) followed by translation of extracted text. The persona-specific instructions may influence formatting, formality level, regional dialect preference, vocabulary substitution rules, and explanatory annotations associated with the translated output. For example, a selected AI persona may provide literal translations, conversational translations, academic translations, or culturally adapted translations depending on the persona's defined communication style. In multimodal embodiments, translated output may be synchronized with persona-specific synthesized speech generated using a voice identifier mapped to the selected AI persona.

In at least one embodiment, the user interface dashboard 346 may allow a user to select a radio mode in which conversational response data generated by the AI persona 350 is integrated with music segments, sound effects, advertisements, news briefings, or other audio content. The radio mode may generate a continuous audio stream comprising alternating segments of synthesized speech and audio media. The AI persona 350 may function as a host, announcer, disc jockey, commentator, or curator and may generate contextual commentary, introductions, transitions, and summaries consistent with persona-specific instructions. The processing unit 110 may coordinate sequencing and timing of speech segments and media segments, and may dynamically interrupt, suspend, or modify the audio stream in response to subsequent user input events as described herein.

Additionally or alternatively, the user interface dashboard 346 may allow a user to initiate content summarization, document analysis, question-answering operations, research assistance, scheduling assistance, project creation, educational mode activation, or external data retrieval functions. Each selected function may operate within a composite instruction architecture that includes master instructions, persona-specific instructions, and optionally task-specific instructions to be used by the one or more AI models 120 in generating the conversational response data.

In at least one embodiment, selection of a different AI persona 350 from the dashboard 346 may cause the processing unit 110 to update the persona identifier within the session state data and apply a different set of persona-specific instructions to subsequent AI operations without terminating the active session. The user interface dashboard 346 may visually indicate the currently active AI persona 350 and may present previews of how a selected function will be executed under that persona's behavioral profile. This architecture may allow users to perform the same AI operation under multiple distinct persona configurations, which may enable comparative outputs, stylistic variation, or domain-specific specialization within a single computing platform.

Accordingly, the user interface dashboard 346 may function as a centralized control interface that integrates multiple AI capabilities into a unified, persona-conditioned computing environment, which may enable coordinated multimodal generation, dynamic persona switching, and structured session management across a plurality of AI operations.

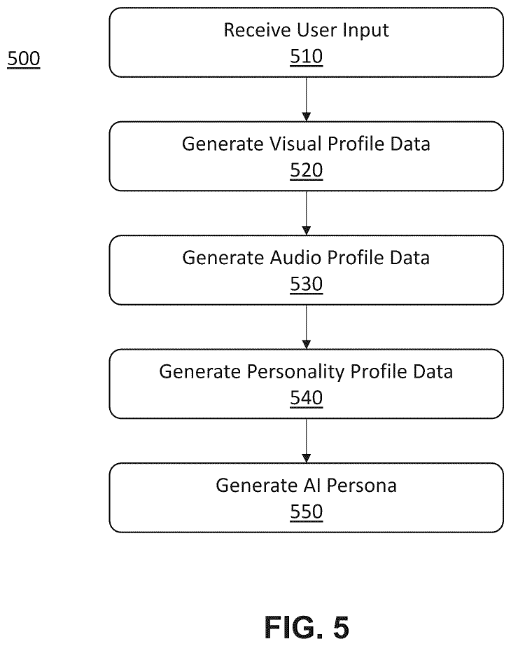

FIG. 5 shows an example method of generating an AI persona according to some embodiments described herein. At least one embodiment of the present disclosure relates to the generation and/or modification of the one or more AI personas described herein. The method 500 may be implemented at least partially by the system 100, in particular at least partially by the processing unit 110. The method 500 may include a first step 510 of receiving user input. The user input may indicate that the user wishes to create an AI persona.

The method 500 may include a second step 520 of generating visual profile data. The visual profile data may include using one or more AI models to generate a picture corresponding to a text or picture based input to generate the visual profile data. The visual profile data may include a received picture and may be customized to the user, which may improve the user experience and allow for the identification of different users within the system.

The method 500 may include a third step 530 of generating audio profile data. The audio profile data may include one or more pre-recorded audio recordings, one or more uploaded audio recordings, and/or one or more recorded audio recordings. The third step 530 may allow a user to generate an AI persona that sounds like the user, which may improve customization and personalization of the AI personas described herein. For example, the audio recording may be recorded audio of the user speaking, and the AI persona may use the audio recording to generate further synthesized speech that sounds similar to the recorded audio.

The method 500 may include a fourth step 540 of generating personality profile data. The personality profile data may be gathered by the AI persona as the user interacts with the AI persona. For example, the AI persona may ask the user a series of questions to construct a personality profile for the AI persona. The personality profile data may include, by way of example and not limitation, humor level, spelling preferences (including word replacement), speech patterns, aspirational goals, motivating factors, and any other personality-related characteristics. The personality profile data may also include one or more formats for a response generated by the AI persona. For example, the personality profile data may allow a user to input particular phrases, spellings, and/or other traits into the response generated by the AI persona. The personality profile data may additionally or alternatively include a purpose of the AI persona, which may be used as part of the generation process by the AI persona.

In at least one embodiment, the visual profile data, the audio profile data, and/or the personality profile data may be included as persona-specific instructions and may be used in generating conversational response data as described herein.

The method 500 may include a fifth step 550 of generating the AI persona based on the visual profile data, the audio profile data, and the personality profile data. In at least one embodiment, the fifth step 550 may include training an AI model based on the visual profile data, the audio profile data, and the personality profile data such that the trained AI model is configured to generate an output corresponding to the visual profile data, audio profile data, and/or the personality profile data.

In at least one embodiment, the user may modify an existing AI persona using a similar method as the method 500. In at least one embodiment, the user may modify an existing AI persona using the user interface 340. In at least one embodiment, the user may enter persona-specific instructions, which may include: (i) hard-coded openings to responses, (ii) personality traits, (iii) preferred vocabulary (including word replacement), (iv) tone parameters, (v) speech cadence settings, (vi) humor levels, (vii) formality levels, (viii) subject-matter preferences, (ix) domain restrictions, (x) spelling preferences, (xi) response formatting rules, and/or (xii) other persona-specific instructions configured to customize the output of the one or more AI models 120. The persona-specific instructions may be stored in a persona profile that corresponds to the AI persona 350 and may be applied to subsequent responses generated by the AI persona 350. The persona-specific instructions may include the visual profile data, the audio profile data, and the personality profile data described herein.

In at least one embodiment, the AI persona may use a specially trained AI model to generate the conversational response data. For example, the specially trained AI model may be trained using the persona-specific instructions as supervised training signals, conditioning parameters, and/or reinforcement objectives such that the specially trained AI model learns to generate conversational response data that consistently reflects behavioral attributes associated with the selected AI persona. In at least one embodiment, training may include fine-tuning a pre-trained large language model on training data constructed to embody the persona-specific instructions, where the training data includes example prompts and corresponding responses that exhibit the defined tone, vocabulary preferences, personality traits, response formatting rules, subject-matter constraints, humor levels, cadence characteristics, and other behavioral parameters associated with the AI persona.

Additionally or alternatively, the persona-specific instructions may be embedded into structured training templates that modify system-level prompts during supervised fine-tuning such that gradients are updated in a manner that biases the model toward persona-consistent outputs. In some embodiments, reinforcement learning techniques may be applied in which model outputs are scored according to alignment with persona-specific criteria, and model parameters are adjusted to increase the likelihood of outputs that satisfy the persona profile. The scoring process may evaluate characteristics such as adherence to defined tone, compliance with domain restrictions, vocabulary substitution rules, response length tendencies, or stylistic consistency.

In at least one embodiment, the training process may additionally or alternatively include multimodal persona characteristics. For example, the visual profile data, audio profile data, and/or personality profile data associated with the AI persona may be jointly encoded during training such that the specially trained model is configured to generate text, synthesized speech characteristics, and optionally associated multimedia outputs that are coherent across modalities. Voice characteristics may be aligned with textual style through joint optimization processes that associate linguistic patterns with specific speech cadence parameters, prosody features, or voice identifiers.

Accordingly, at least one embodiment of the one or more AI models 120 (e.g., the specially trained AI model described above) may internalize persona-specific behavioral parameters at the model level rather than relying on runtime prompt conditioning, which may enable more efficient, consistent, and low-latency generation of conversational response data that reflects the selected AI persona.

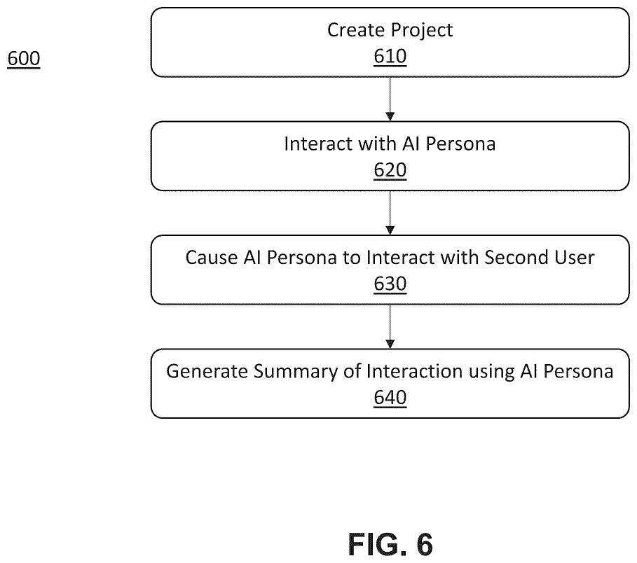

FIG. 6 shows an example method of interfacing with one or more AI personas according to some embodiments described herein. The method 600 may be implemented by the system 100 and may provide for an improved interface with an AI model. The method 600 may include a first step 610 of creating a project. The project may be created in the one or more storage devices of the processing unit 110 of the system 100 and/or may be stored remotely from the system 100. The project may be a project object in the one or more storage devices that has distinct session state data. For example, the user may interact with the AI persona in a second step 620 to enhance the productivity of the user. Interacting with the AI persona may include inputting user input and receiving generated output according to embodiments described herein.

In at least one embodiment, the project may be associated with a plurality of users. In such embodiments, the users may cause the AI persona to interact with the other users in a third step 630. For example, a first user may input a prompt for the AI persona to call a second user, for example using a Voice over Internet Protocol (VoIP). Thus, in at least one embodiment, the communication module 150 of the system 100 may be configured to enable the AI persona to initiate outbound communications to the second user via a communication protocol, including but not limited to Voice over Internet Protocol (VoIP), telephony systems, messaging platforms, application programming interfaces, or other communication protocols. The AI persona may generate conversational content during such communication and may store a transcript or structured summary within the project object.

Additionally or alternatively, the first user may input a prompt for the AI persona to enter into a text-based conversation with the second user to achieve and report on one or more goals. The goals may be associated with the project, for example a completion date, specific task, and/or direction of the project. At least one embodiment described herein may thus provide for improved interface with AI models, including with one or more AI personas.

The method 600 may include a fourth step 640 of generating a summary of the interaction using the AI persona. For example, the AI persona may generate a summary of the interaction with the second user, which may indicate what the second user responded. The AI persona may thus generate a summary and present it to the first user in accordance with the personality profile associated with the AI persona, which may offer an improvement over conventional AI models.

In at least one embodiment, the system 100 may implement the third step 630 and the fourth step 640 independently from any project. For example, the first user may cause the AI persona to interact with the second user (e.g., by calling and/or engaging the second user in a text-based conversation) independently from any project being created. This may offer an improvement over conventional AI models by enabling the AI persona to interact with multiple different users based on the associated persona-specific instructions for the AI persona.

In at least one embodiment, the system 100 may implement the first step 610 independently from the remaining steps 620-640. For example, the system 100 may be configured to allow a user to create a project without immediately initiating interaction with an AI persona. The created project may define a persistent workspace associated with one or more users, one or more AI personas, and/or one or more project-specific parameters. The project may remain stored in memory and may be accessed for future interactions.

In at least one embodiment, the project may be implemented as a structured data object stored in memory. The structured data object may include a project identifier, a list of associated users, one or more associated AI personas, project-specific instructions, stored conversation history, task metadata, goal definitions, deadlines, and/or state variables. The project-specific instructions may modify operation of the AI persona when interactions occur within the project context.

In at least one embodiment, the project object may include one or more goal parameters. The AI persona may monitor conversation content to determine progress toward the one or more goal parameters. Upon detecting completion of a goal or deviation from a goal, the AI persona may generate a notification or summary within the project

Additionally or alternatively, responses generated by the AI persona within a project may be conditioned on a composite instruction architecture that includes (i) master system instructions, (ii) persona-specific instructions, and (iii) project-specific instructions. The project-specific instructions may define objectives, deliverables, tone constraints, collaboration rules, and/or completion criteria associated with the project.

Each project may maintain an independent session state data separate from other projects. The independent session state data may include conversation history, retrieved external information, intermediate reasoning data, summaries, task progress indicators, and/or user interaction logs. Isolation of session states between projects may prevent cross-project contamination of contextual information.

In embodiments including multiple users, the project may include user role definitions. The role definitions may define permissions such as initiating AI interactions, modifying project goals, reviewing summaries, or editing project-specific instructions. The AI persona may condition responses based on the role of the interacting user.

The user interface dashboard 346 may allow the user to select a project from one or more projects and begin interacting with the AI persona within the project. Thus, at least one embodiment of the system 100 may provide improved security and presentation of data, as each project may be isolated from another. In at least one embodiment, the AI persona may be configured to create a project from the conversation interface 345 based on user input indicating that the project should be created.

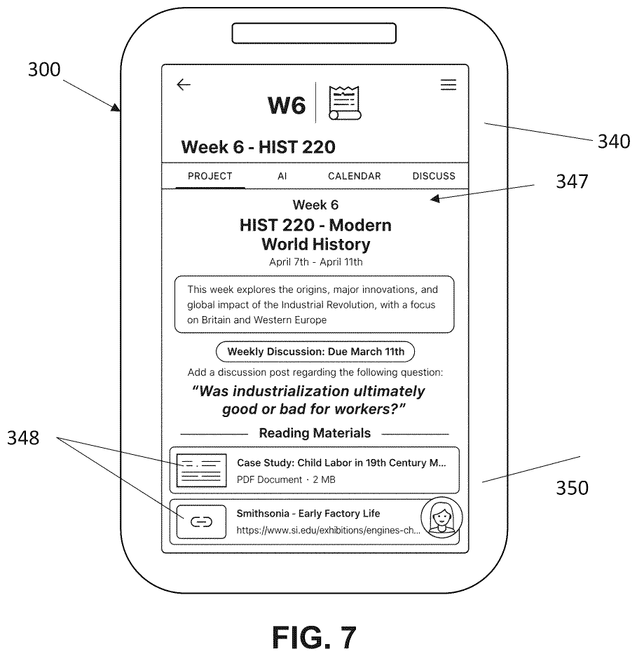

FIG. 7 illustrates an education interface provided on a smartphone that is configured to implement a system for interfacing with one or more AI personas according to some embodiments described herein. FIG. 7 shows that, by way of example and not limitation, the project may be an education-based project configured to provide the user with a suite of educational tools. In at least one embodiment, the education-based project may be presented using an education interface 347 presented on the user interface 340. The education interface 347 may present structured educational content associated with the education-based project including prerecorded lectures, AI-generated lectures, lesson modules, infographics, slide-based presentations, quizzes, assignments, and progress-tracking tools. The lectures may be delivered in text form, audio form using synthesized speech associated with a selected AI persona, video form, or combinations thereof. The one or more AI personas may function as virtual instructors, tutors, or subject-matter experts configured to present educational material according to persona-specific teaching styles, tones, pacing, and difficulty levels.

In at least one embodiment, the education interface 347 may be configured to provide interactive learning sessions in which the user may interrupt a lecture to ask questions, request clarification, change difficulty levels, request alternative explanations, generate practice problems, or switch to a different AI persona acting as a different instructor. Session state data associated with the education-based project may include course progress data, completed modules, assessment results, topic mastery indicators, and personalized learning preferences. The one or more AI models 120 may generate adaptive educational content based on this stored educational account data, which may provide a customized and dynamically updated learning experience that supplements formal education and improves knowledge retention and engagement.

The education interface 347 may also present one or more external documents 348 that may supplement the education. The one or more external documents 348 may include PDF files, web links, e-books, research articles, primary source documents, multimedia resources, and/or other third-party educational content. In at least one embodiment, the processing unit 110 may retrieve metadata associated with the one or more external documents 348 and generate corresponding preview cards that include a document title, source identifier, file type indicator, file size indicator, thumbnail image, and/or summary description. The one or more external documents 348 may be selectable such that user interaction causes the document to be opened within the education interface 347 or within an embedded document viewer.

In at least one embodiment, the one or more AI models 120 may analyze content of the one or more external documents 348 to generate summaries, highlight key passages, generate discussion questions, create practice quizzes, extract citations, or adapt the content to a selected AI persona's teaching style. The content of the one or more external documents 348 may be incorporated into session state data associated with the education-based project, thereby allowing subsequent conversational responses to reference the external documents while maintaining contextual continuity within the active educational session.

By integrating structured educational content with dynamically configurable AI personas and persistent project-specific session state data, at least one embodiment of the system 100 may enable real-time adaptation of lectures, explanations, and assessments based on user interaction and progress. The ability to interrupt instructional media, modify instructional parameters, switch instructional personas, and generate updated educational content within a single persistent project context may reduce latency between user inquiry and instructional response while preserving contextual continuity. This architecture may improve computational efficiency through controlled session state isolation, reduce unnecessary regeneration of content, and enable scalable delivery of personalized instruction. As a result, at least one embodiment of the system 100 may provide a technically enhanced human-computer interaction model for education, offering adaptive, multimodal, and AI persona conditioned learning experiences that may not be achievable using conventional pre-recorded or non-interruptible educational systems.

Thus, at least one embodiment described herein may provide practical applications in the field of human-computer interaction by improving the manner in which AI-generated content is organized, delivered, and dynamically controlled during active user sessions. For example, at least one embodiment may enable real-time suspension of streaming audio output in response to newly detected user input events, preservation and structured updating of session state data across persona transitions, and coordinated multi-modal output generation that synchronizes text, audio, and multimedia elements. These features may improve responsiveness, reduce computational waste associated with generating unused media segments, and enhance the technical operation of computing devices that implement the embodiments described herein.

Additionally or alternatively, at least one disclosed embodiment may provide technical improvements in the management of AI personas and conversational contexts by implementing a composite instruction architecture that includes master instructions, persona-specific instructions, and optionally project-specific instructions stored within session state data structures. This architecture may enable dynamic switching between AI personas within a single conversational session while retaining contextual continuity, which may improve memory management, session isolation, and structured data handling across multiple concurrent interactions. By integrating conversational AI, multimedia generation, and external data retrieval within a unified dashboard interface, at least one embodiment described herein may provide a technically improved computing platform for multi-domain AI interaction that enhances processing efficiency, user input handling, and coordinated media rendering.

Further, the methods may be practiced by a computer system including one or more processors and computer-readable media such as computer memory. In particular, the computer memory may be a non-transitory storage medium that is configured to store computer-executable instructions thereon that when executed by one or more processors cause various functions to be performed, such as the acts recited in the embodiments.

Computing system functionality can be enhanced by a computing system's ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the disclosure can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Additionally, unless such is mutually exclusive, terms such as “and”, “or”, and “and/or” are intended to convey that the referenced elements may be present individually, collectively, or in any combination thereof. For example, a reference to “A and/or B” is intended to encompass A alone, B alone, and both A and B together. Similarly, references to “at least one of” a list of elements are intended to include any single element of the list as well as any combination of two or more elements of the list.

Unless otherwise expressly stated, the terms “comprising,” “including,” “having,” and variations thereof are intended to be open-ended and non-limiting. Additionally, singular forms such as “a,” “an,” and “the” are intended to include plural forms unless the context clearly indicates otherwise. Terms such as “configured to,” “adapted to,” or “operable to” are intended to describe structural or functional capability and are not intended to require actual operation in all embodiments.

It will be appreciated that the various embodiments and features described herein are not necessarily mutually exclusive and may be combined in whole or in part with one another unless expressly stated otherwise or unless such combination would be inoperable. Features described in connection with one embodiment may be incorporated into other embodiments, and elements described in connection with particular implementations may be interchanged or substituted with equivalent elements described elsewhere in the specification. Accordingly, the scope of the present disclosure includes combinations and sub-combinations of the described features and embodiments, even if such combinations are not explicitly illustrated or described in a single embodiment.

If a first embodiment and/or component is described herein as being “similar to” or “the same as” a second embodiment and/or component, it should be understood that the structural features, functional characteristics, operational steps, and/or implementation details described with respect to one embodiment or component may be applicable to the other, unless expressly stated otherwise or unless such application would be inoperable. Accordingly, description provided for one embodiment or component may be incorporated by reference into the description of another embodiment or component, and vice versa, even if not repeated in full. The absence of explicit repetition is not intended to limit the scope of the disclosure or to imply that features are restricted to only the embodiment in which they are first described.

The present disclosure may be embodied in other specific forms without departing from its spirit or characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

The present disclosure may be embodied in one or more additional or alternative implementations as follows.
Implementation 1. A system for interfacing with one or more AI personas, comprising: a speaker; a microphone; a touch-sensitive display; and a processing unit connected to the speaker, the microphone, and the touch-sensitive display, wherein the processing unit comprises one or more processors and one or more non-transitory computer-readable storage devices that have one or more instructions stored thereon that are configured to cause the one or more processors to: receive, from the touch-sensitive display and/or the microphone, user input associated with an active user session, wherein the active user session comprises session state data that includes a persona identifier corresponding to a selected AI persona and one or more persona-specific instructions associated with the persona identifier; generate, using an AI model, conversational response data based on the user input and the session state data; generate media data based at least partially on the conversational response data and the persona identifier; output the media data using the speaker and/or the touch-sensitive display; detect, while outputting the media data, a subsequent user input event; and in response to detecting the subsequent user input event: suspend the output of the media data; update the session state data with the subsequent user input event to form updated session state data; generate, using the AI model and the one or more persona-specific instructions, updated conversational response data based on the updated session state data; generate updated media data based at least partially on the updated conversational response data; and output the updated media data using the speaker and/or the touch-sensitive display.
Implementation 2. The system of any or a combination of implementation 1 and/or implementations 3-6, wherein the subsequent user input event comprises activation of the microphone and receipt of audio data from the microphone.
Implementation 3. The system of any or a combination of implementations 1-2 and/or implementations 4-6, wherein the subsequent user input event comprises receiving text input via the touch-sensitive display.
Implementation 4. The system of any or a combination of implementations 1-3 and/or implementations 5-6, wherein the instructions are further configured to provide, on the touch-sensitive display, a conversation interface configured to allow the user to interact with a selected AI persona via text input or voice input, wherein the conversation interface is further configured to display text corresponding to at least a portion of the conversational response data concurrently with outputting the media data.
Implementation 5. The system of any or a combination of implementations 1-4 and/or implementation 6, wherein the session state data further comprises a master prompt and wherein the one or more persona-specific instructions modify behavior of the AI model relative to the master prompt.
Implementation 6. The system of any or a combination of implementations 1-5, wherein the media data and/or the updated media data comprise at least one segment of synthesized speech audio and at least one music segment.
Implementation 7. A non-transitory computer-readable storage medium storing instructions that are executable by one or more processors to cause the one or more processors to perform operations comprising: receiving user input associated with an active user session, wherein the active user session comprises session state data; generating, using an AI model, conversational response data based on the user input and the session state data; generating media data based at least partially on the conversational response data; outputting the media data; detecting, while outputting the media data, a subsequent user input event; and in response to detecting the subsequent user input event: suspending output of the media data; updating the session state data with the subsequent user input event to form updated session state data; generating, using the AI model, updated conversational response data based on the updated session state data; generating updated media data based at least partially on the updated conversational response data; and outputting the updated media data.
Implementation 8. The non-transitory computer-readable storage medium of any one or a combination of implementation 7 and/or implementations 9-18, wherein receiving the user input comprises receiving at least one of: (i) text entered via a user interface, (ii) speech captured by a microphone, (iii) a selection of a suggested prompt, (iv) a tap or gesture input, or (v) an upload of a media item.
Implementation 9. The non-transitory computer-readable storage medium of any one or a combination of implementations 7-8 and/or implementations 10-18, wherein the subsequent user input event comprises an activation of a microphone and a recording from the microphone.
Implementation 10. The non-transitory computer-readable storage medium of any one or a combination of implementations 7-9 and/or implementations 11-18, wherein the subsequent user input event comprises receiving a text input from a user.
Implementation 11. The non-transitory computer-readable storage medium of any one or a combination of implementations 7-10 and/or implementations 12-18, wherein generating the conversational response data comprises performing an information retrieval operation to obtain real-time or fact-based data and further using the real-time or fact-based data to generate the conversational response data.
Implementation 12. The non-transitory computer-readable storage medium of any one or a combination of implementations 7-11 and/or implementations 13-18, wherein suspending the outputting of the media data comprises at least one of: pausing the outputting, stopping the outputting, or fading out the outputting.
Implementation 13. The non-transitory computer-readable storage medium of any one or a combination of implementations 7-12 and/or implementations 14-18, wherein the session state data comprises conversation history data including at least one of: prior user messages, prior AI responses, timestamps, or metadata associated with the active user session.
Implementation 14. The non-transitory computer-readable storage medium of any one or a combination of implementations 7-13 and/or implementations 15-18, wherein the session state data comprises a persona identifier associated with an AI persona selected for the active user session.
Implementation 15. The non-transitory computer-readable storage medium of any one or a combination of implementations 7-14 and/or implementations 16-18, wherein updating the session state data comprises changing, based on the user input, the persona identifier associated with the AI persona selected for the active user session.
Implementation 16. The non-transitory computer-readable storage medium of any one or a combination of implementations 7-15 and/or implementations 17-18, wherein the session state data comprises a master prompt and persona-specific instructions for the AI persona, and wherein generating the conversational response data is further based on the master prompt and the persona-specific instructions.
Implementation 17. The non-transitory computer-readable storage medium of any one or a combination of implementations 7-16 and/or implementation 18, wherein generating the media data comprises using a voice identifier mapped to the AI persona, wherein the voice identifier is selected from a plurality of voice identifiers.
Implementation 18. The non-transitory computer-readable storage medium of any one or a combination of implementations 7-17, wherein the media data and/or the updated media data comprise at least one segment of generated speech audio and at least one segment of music audio.
Implementation 19. A system for dynamically managing AI personas within a conversational session, comprising: one or more processors; and one or more non-transitory computer-readable storage devices that have one or more instructions stored thereon that are configured to cause the one or more processors to: receive a first user input associated with a conversational session, wherein the conversational session comprises session state data that comprises first persona-specific instructions that correspond to a first AI persona; generate, using an AI model and first persona-specific instructions, first conversational response data; receive, during the conversational session, a second user input indicating selection of a second AI persona; modify the session state data by replacing the first persona-specific instructions with second persona-specific instructions that correspond to the second AI persona while retaining at least a portion of session state data from the conversational session; and generate, using the AI model and the second persona-specific instructions, second conversational response data based at least partially on the portion of session state data.
Implementation 20. The system of implementation 19, wherein the first persona-specific instructions and the second persona-specific instructions define different tone, style, and/or personality attributes applied by the AI model when generating conversational responses.

What is claimed is:

1. A system for interfacing with one or more artificial intelligence (AI) personas, comprising:
a speaker;
a microphone;
a touch-sensitive display;
and a processing unit connected to the speaker, the microphone, and the touch-sensitive display, wherein the processing unit comprises one or more processors and one or more non-transitory computer-readable storage devices that have one or more instructions stored thereon that are configured to cause the one or more processors to:
receive, from the touch-sensitive display and/or the microphone, user input associated with an active user session, wherein the active user session comprises session state data that includes a persona identifier corresponding to a selected AI persona and one or more persona-specific instructions associated with the persona identifier;
generate, using an AI model, conversational response data based on the user input and the session state data;
generate media data based at least partially on the conversational response data and the persona identifier;
output the media data using the speaker and/or the touch-sensitive display;
detect, while outputting the media data, a subsequent user input event; and
in response to detecting the subsequent user input event:
suspend the output of the media data;
update the session state data with the subsequent user input event to form updated session state data;
generate, using the AI model and the one or more persona-specific instructions, updated conversational response data based on the updated session state data;
generate updated media data based at least partially on the updated conversational response data; and
output the updated media data using the speaker and/or the touch-sensitive display.

2. The system of claim 1, wherein the subsequent user input event comprises activation of the microphone and receipt of audio data from the microphone.

3. The system of claim 1, wherein the subsequent user input event comprises receiving text input via the touch-sensitive display.

4. The system of claim 1, wherein the instructions are further configured to provide, on the touch-sensitive display, a conversation interface configured to allow the user to interact with a selected AI persona via text input or voice input,
wherein the conversation interface is further configured to display text corresponding to at least a portion of the conversational response data concurrently with outputting the media data.

5. The system of claim 1, wherein the session state data further comprises a master prompt and wherein the one or more persona-specific instructions modify behavior of the AI model relative to the master prompt.

6. The system of claim 1, wherein the media data and/or the updated media data comprise at least one segment of synthesized speech audio and at least one music segment.

7. A non-transitory computer-readable storage medium storing instructions that are executable by one or more processors to cause the one or more processors to perform operations comprising:
receiving user input associated with an active user session, wherein the active user session comprises session state data;
generating, using an AI model, conversational response data based on the user input and the session state data;
generating media data based at least partially on the conversational response data;
outputting the media data;
detecting, while outputting the media data, a subsequent user input event; and
in response to detecting the subsequent user input event:
suspending output of the media data;
updating the session state data with the subsequent user input event to form updated session state data;
generating, using the AI model, updated conversational response data based on the updated session state data;
generating updated media data based at least partially on the updated conversational response data; and
outputting the updated media data.

8. The non-transitory computer-readable storage medium of claim 7, wherein receiving the user input comprises receiving at least one of: (i) text entered via a user interface, (ii) speech captured by a microphone, (iii) a selection of a suggested prompt, (iv) a tap or gesture input, or (v) an upload of a media item.

9. The non-transitory computer-readable storage medium of claim 7, wherein the subsequent user input event comprises an activation of a microphone and a recording from the microphone.

10. The non-transitory computer-readable storage medium of claim 7, wherein the subsequent user input event comprises receiving a text input from a user.

11. The non-transitory computer-readable storage medium of claim 7, wherein generating the conversational response data comprises performing an information retrieval operation to obtain real-time or fact-based data and further using the real-time or fact-based data to generate the conversational response data.

12. The non-transitory computer-readable storage medium of claim 7, wherein suspending the output of the media data comprises at least one of: pausing the outputting, stopping the outputting, or fading out the outputting.

13. The non-transitory computer-readable storage medium of claim 7, wherein the session state data comprises conversation history data including at least one of: prior user messages, prior AI responses, timestamps, or metadata associated with the active user session.

14. The non-transitory computer-readable storage medium of claim 7, wherein the session state data comprises a persona identifier associated with an AI persona selected for the active user session.

15. The non-transitory computer-readable storage medium of claim 14, wherein updating the session state data comprises changing, based on the user input, the persona identifier associated with the AI persona selected for the active user session.

16. The non-transitory computer-readable storage medium of claim 14, wherein the session state data comprises a master prompt and persona-specific instructions for the AI persona, and wherein generating the conversational response data is further based on the master prompt and the persona-specific instructions.

17. The non-transitory computer-readable storage medium of claim 14, wherein generating the media data comprises using a voice identifier mapped to the AI persona, wherein the voice identifier is selected from a plurality of voice identifiers.

18. The non-transitory computer-readable storage medium of claim 7, wherein the media data and/or the updated media data comprise at least one segment of generated speech audio and at least one segment of music audio.

19. A system for dynamically managing AI personas within a conversational session, comprising:
one or more processors; and
one or more non-transitory computer-readable storage devices that have one or more instructions stored thereon that are configured to cause the one or more processors to:
receive a first user input associated with a conversational session, wherein the conversational session comprises session state data that comprises first persona-specific instructions that correspond to a first AI persona;
generate, using an AI model and first persona-specific instructions, first conversational response data;
receive, during the conversational session, a second user input indicating selection of a second AI persona;
modify the session state data by replacing the first persona-specific instructions with second persona-specific instructions that correspond to the second AI persona while retaining at least a portion of session state data from the conversational session; and
generate, using the AI model and the second persona-specific instructions, second conversational response data based at least partially on the portion of session state data.

20. The system of claim 19, wherein the first persona-specific instructions and the second persona-specific instructions define different tone, style, and/or personality attributes applied by the AI model when generating conversational responses.
